(19) United States
(12) Patent Application Publication
(10) Pub. No.: US 2016/0110766 A1
(43) Pub. Date: Apr. 21, 2016

(54) SYSTEM AND METHOD OF DISPLAYING SOCIAL ADS ALONG WITH ORGANIC OR PAID SEARCH RESULTS

(71) Applicant: Oracle International Corporation, Redwood Shores, CA (US)

(72) Inventor: Anand N. Katti, Bangalore (IN)

(21) Appl. No.: 14/516,280

(22) Filed: Oct. 16, 2014

(51) Int. Cl. G06Q 30/02; H04L 29/08; G06Q 50/00; G06F 17/30

(52) U.S. Cl. CPC G06Q 30/0256; G06F 17/30554; H04L 67/02; G06F 17/30914; G06Q 50/01; G06Q 30/0267

(57) ABSTRACT

Automated processes gather information about a user from social media sources and store this information in association with the user's identity within a repository. A search engine receiving search query terms from a user can retrieve this information from the repository and can query an advertisement database using keywords derived from the information in order to obtain “social advertisements.” The search engine can generate a search results web page in which the social advertisements are distinguished from other types of advertisements that might also be included in the page. The search engine can send the web page to the user's device in response to a user's original search query. The user's experience is enhanced by the presentation of the social advertisements, which, because they can be based on information that the user himself has posted on-line, can be more likely to interest the user than other kinds of advertisements are.

### BACKGROUND

The present disclosure relates to on-line advertising and social media, and more particularly to the selection of advertisements based on information available through social media.

People are social animals. This trait might explain the massive popularity that on-line social media sites such as Facebook and Twitter have achieved since their introductions, some just over a decade ago. Using such social media sites, people can publish information to virtually anyone else who is interested in consuming that information. The kind of publication involved in social media sites can be distinguished from other more general kinds of publication performed on-line (e.g., on web pages available on the World Wide Web generally) in that the kinds of publications made through social media sites are typically targeted to a specific set of other people individually identified by the author. Publications made on social media sites can not only be directed to a specific set of such people, but also restricted by the author to that specific set of people as well. Publications on social media sites have a highly focused audience and intent.

Perhaps because social media publications (e.g., status updates, tweets, etc.) authored by a user are so intrinsically focused, and because their distribution is often highly controllable by the author, users are often more comfortable revealing personalized information about themselves within social media publications than they might be in more public venues. Indeed, it could be argued that the whole purpose of social media is to provide a channel through which an author can reveal information of a personal nature to a circle of individuals with whom that author believes he has some trusted relationship, such as a friendship, romantic attachment, familial bond, or professional association. Most people desire attention from other people, and publications made through social media usually are specifically intended to generate that attention in specific people of the author's choice through the revelation, to those specific people, of personal information that the author likely would not share with the general public (although some social media sites can also allow authors to do that as well, if they so choose). Social media publications can expose the kinds of intimate details about a person that are much less likely to be encountered anywhere else.

Besides providing avenues for people to relate to one another on a personal level, another great purpose of the Internet is to make money. In order to generate business, one finds it prudent to advertise his products or services on sale. Popular sites on the Internet, such as on-line search engines (e.g., Google, Yahoo, Bing, etc.) to which multitudes of people direct their Internet browsers every day in order to find information of interest on-line, are prime advertising locations. Because such a vast amount of people view on-line search results generated by these search engines on a very frequent basis, advertisements placed within these search results potentially receive considerably more attention than do advertisements conveyed through other conventional media such as radio, television, magazine, newspaper, billboard, gossip, etc. Moreover, the interactive and individualized nature of the on-line experience makes the real-time tailoring of advertising to specific people having specific interests more possible than ever. The discovery of these interests, then, becomes a much-sought holy grail of advertising.

If only advertisers, with whom authors of social media publications probably have not established any kind of trusting relationship, could access the vast wealth of personal information that has been hidden from them, they might be able to harness that information to very lucrative ends.

### BRIEF SUMMARY

According to embodiments, automated processes periodically gather information over the Internet from various on-line sources that are associated with a user. These on-line sources can include various social media sites or feeds, such as Facebook, Twitter, etc. The information gathered from these on-line sources can include information that the user himself has placed within those sources. For example, the information can include information authored by the user, such as Facebook posts or comments, Twitter tweets, etc. The automated processes can store this information in association with the user's identity within a repository.

Asynchronously, using a custom application programming interface (API), an on-line search engine (e.g., Google, Yahoo, Bing, etc.) receiving a user-specified search query from the user's device over the Internet can retrieve the stored information associated with the user's identity in the repository. In addition to compiling organic search results based on the search query terms received from (and expressly specified by) the user, the search engine can separately query an advertisement database using keywords that the search engine has derived from the stored information associated with the user's identity in the repository. The keywords are likely to represent subjects in which the user is interested. In response to this separate query, the search engine can receive, from the advertisement database, advertisements that are associated with the keywords. Because these advertisements can be based on information that has been gleaned from social media sources, these advertisements are called “social advertisements.”

The on-line search engine can use its own compiled organic search results as well as the social advertisements in order to generate a search results web page. In generating the search results web page, the search engine can segregate the social advertisements from other types of advertisements that might also be included in the page by grouping the social advertisements together in a section that is visibly separate and distinct from other sections in which other types of advertisements might be placed. Thus, the search engine can generate a web page that contains the social advertisements in addition to links to the search results, and potentially in addition to other kinds of non-social advertisements.

The search engine can send the web page back over the Internet to the user's device in response to the user's original search query. Upon receiving the web page, an Internet browser application executing on the user's device can render the web page and display the web page, including the social advertisements, to the user. The user's experience is enhanced by the presentation of the social advertisements, which, because they can be based on information that the user has posted on-line, can be more likely to interest the user.

### BRIEF DESCRIPTION OF THE DRAWINGS

FIG. 1 is a system diagram that illustrates a system for harvesting social media publications and selecting, based on the harvested information, social media advertisements for inclusion in documents to be presented to an author of those social media publications, according to some embodiments.

FIG. 2 is a diagram that illustrates an example of a search results web page that includes multiple distinct sections, one of which is devoted exclusively to social advertisements, according to some embodiments.

FIG. 3 is a flow diagram that illustrates a technique for generating a search results web page that includes social advertisements selected based on publications harvested from a user's various social media site accounts, according to some embodiments.

FIG. 4 depicts a simplified diagram of a distributed system for implementing one of the embodiments.

FIG. 5 is a simplified block diagram of components of a system environment by which services provided by the components of an embodiment system may be offered as cloud services, in accordance with an embodiment of the present disclosure.

FIG. 6 illustrates an example of a computer system in which various embodiments of the present invention may be implemented.

### DETAILED DESCRIPTION

In the following description, for the purposes of explanation, specific details are set forth in order to provide a thorough understanding of embodiments of the invention. However, it will be apparent that various embodiments may be practiced without these specific details. The figures and description are not intended to be restrictive.

Systems depicted in some of the figures may be provided in various configurations. In some embodiments, the systems may be configured as a distributed system where one or more components of the system are distributed across one or more networks in a cloud computing system.

### Harvesting Social Media Publications to Select Advertisements

In some embodiments, automated processes periodically harvest social media publications (e.g., Facebook statuses and comments, Twitter tweets, LinkedIn updates, Pinterest pins, Instagram photo metadata, etc.) to which they have been given access by the authors of those publications. These processes make the harvested information available to interested entities such as on-line search engines. The interested entities can use the harvested information to select social advertisements for presentation to those same authors through channels other than those that were used to publish the information. For example, an on-line search engine can insert such social advertisements into a dynamically generated web page containing organic search results that were requested by the same user who previously authored the harvested information that the search engine used to select those social advertisements. The search engine (or other interested entity) can be unaffiliated with the sources of the social media publications used to select the social advertisement.

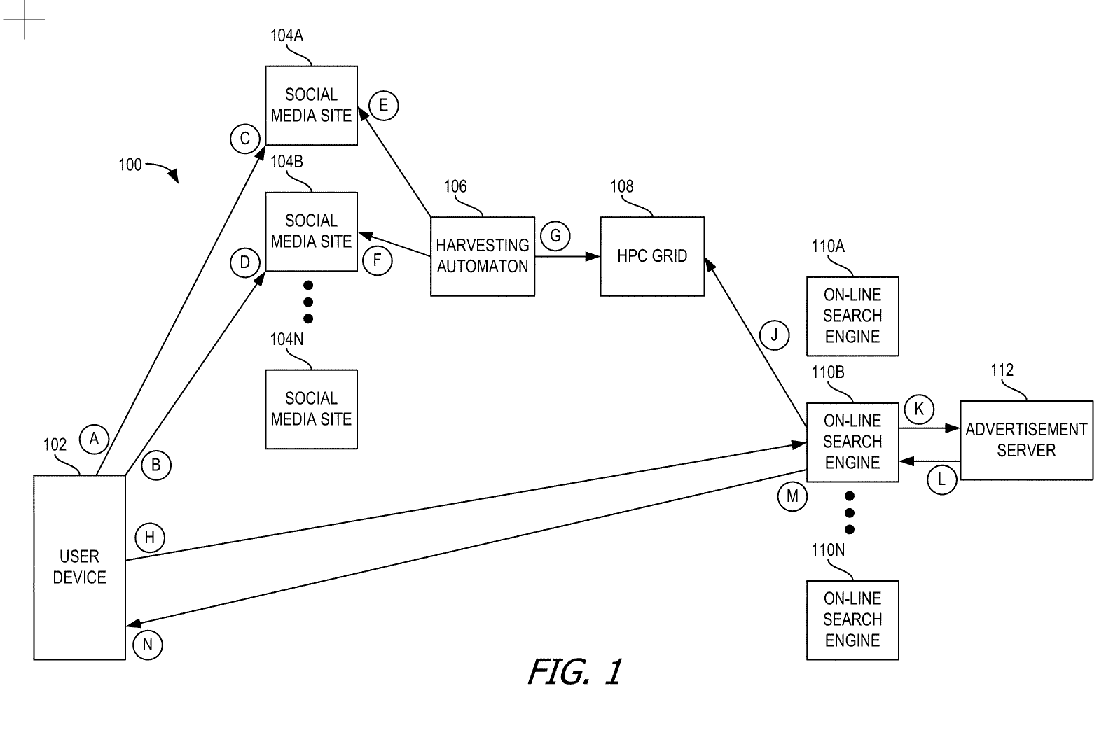

FIG. 1 is a system diagram that illustrates a system 100 for harvesting social media publications and selecting, based on the harvested information, social media advertisements for inclusion in documents to be presented to an author of those social media publications, according to some embodiments. Although the example illustrated in FIG. 1 involves specific system components interacting in a specific manner, alternative embodiments can involve additional, fewer, or different system components interacting in different manners than those illustrated.

System 100 includes a user device 102, social media sites 104A-N, a harvesting automaton 106, a high-performance computing (HPC) grid 108, on-line search engines 110A-N, and an advertisement server 112. These components can interact with each other through requests and responses that they transmit to and receive from each other via an interconnected system of computing networks potentially including the Internet.

User device 102 can be any computing device capable of sending and receiving information over a network such as the Internet. For example, user device 102 can be a smart phone, a tablet computing device, a laptop computing device, a desktop computing device, etc. An Internet browser application (e.g., Mozilla Firefox, Microsoft Internet Explorer, Google Chrome, Apple Safari, etc.) can execute on user device 102. Through this and/or possibly other applications executing on user device 102, a user of user device 102 can send information over computing networks to various different ones of social media sites 104A-N for publication. In operation A, user device 102 sends information to social media site 104A for publication on social media site 104A. In operation B, user device 102 sends information to social media site 104B for publication on social media site 104B.

Social media sites 104A-N can include Internet-based social media sites such as Facebook, Twitter, LinkedIn, Pinterest, Instagram, etc. Typically, social media sites such as these maintain separate password-protected accounts for different users. These social media sites store information received from a particular user in connection with that particular user's account. These social media sites maintain pages (e.g., “walls”), feeds, or other dynamically generated and intermittently updated documents that contain this information. By making such a document accessible to computing devices of other interested users over an interconnected system of computing networks, these social media sites publish the information stored in connection with user accounts.

Usually, in the context of social media sites, each user's account is also associated with a set of other specified users individually selected by that account's user. These other specified users—“friends” or “contacts”—usually also have their own separate accounts maintained at the same social media site. Typically, for each particular user for which a social media site maintains an account, that site only allows the other specified users in the set associated with the particular user's account to access the information stored in the document generated for the particular user's account. In this manner, social media sites restrict access to user publications.

Often, social media sites also automatically compile information that has been published to the documents (e.g., profiles or “walls”) of various users. The social media sites compile this information into a feed that the social media sites present to the particular user. The compiled information is drawn from documents of other users in whom a particular user has expressed interest (e.g., through subscription or through the formation of a mutual relationship). In this manner, social media sites attempt to show, to the particular user, others' (e.g., friends′) publications (e.g., posts, comments, statuses, updates, photos, videos, etc.) estimated by the social media sites to be of probable interest to the particular user. Thus, instead of waiting for a particular user to “pull” selected publications of others, a social media site can proactively “push” these selected publications to the particular user by inserting these selected publications into the particular user's feed, sometimes in chronological order of publication. Through all these and other characteristics that social media sites usually possess, social media sites can be distinguished from a general population of web sites.

In operation C, social media site 104A stores the information received from user device 102 in association with an account associated with the user of user device 102. In operation D, social media site 104B stores the information received from user device 102 in association with the account associated with the user of user device 102. Social media sites 104A and 104B can incorporate this information into account-associated documents that are made accessible through publication, as discussed above, to other users. Social media sites 104A and 104B can make this information available to others in the form of publications. It should be understood that operations A and C can be performed in concert, and that operations B and D can be performed in concert, and that operations A and C can both precede operations B and D.

In operation E, harvesting automaton 106 reads publications from social media site 104A. In operation F, harvesting automaton 106 reads publications from social media site 104B. Harvesting automaton 106 can take the form of one or more continuously executing processes that periodically, or in response to the occurrences of specified events, access certain ones of the account-associated documents that are maintained by social media sites 104A-N. As is discussed above, these documents contain publications from users such as a user of device 102. This access can occur asynchronously to the dynamic generating and updating of those documents. For example, harvesting automation 106 can periodically check various documents to determine whether they have been updated since a last time that harvesting automaton 106 checked, and can access any information that has been added to those documents in response to an affirmative result. Harvesting automaton 106 can execute on one or more computing devices such as servers.

In some embodiments, harvesting automaton 106 obtains authorizations from users that are associated with the social media site accounts from which harvesting automaton 106 gleans publications prior to accessing the publications of those users. Harvesting automaton 106 can do so through a process by which a user's Internet browser application is redirected to a selected one of social media sites 104A-N. That social media site can request log-in credentials from the user to authenticate the user. Following successful authentication, the social media site can ask the user for permission to share his publications maintained by the social media site with an identified entity who operates harvesting automaton 106.

After obtaining the user's consent, the social media site can provide a user account-specific authorization token manifesting that consent to harvesting automaton 106. Harvesting automation 106 can store that authorization token and thereafter can present it (on potentially multiple separate occasions) to the social media site that issued the authorization token as evidence that harvesting automaton 106 is authorized to access a limited subset of the information (e.g., publications, but perhaps not other information) associated with the token-identified account. Harvesting automation 106 therefore does not need to revisit this authorization procedure after its initial performance for a particular user's account on a particular social media site. The authorization procedure discussed above can be implemented using the OAuth protocol, example usages of which are described in U.S. Patent Application Publication No. 2013/0086645, titled “OAUTH FRAMEWORK,” which is incorporated by reference herein for all purposes.

In some embodiments, harvesting automaton 106 can concurrently read data from publications stored at multiple separate social media sites 104A-N concurrently. Harvesting automaton 106 can be implemented as a multi-threaded process with concurrently executing threads assigned to different social media sites 104. Harvesting automaton 106 can call the same routines of a custom application programming interface (API) in order to retrieve data from diverse and heterogeneous sites among social media sites 104A-N. The API can insulate harvesting automaton 106 from the variances and pecularities of the interfaces exposed by social media sites 104A-N. The API can abstract each of these potentially variant interfaces through a common unified interface that harvesting automaton 106 can invoke regardless of the type of social media site with which it is communicating.

Harvesting automaton 106 can store the publications that it harvests from social media sites 104A-N in a centralized repository that is accessible through a system of interconnected computing networks including the Internet. In system 100, this centralized repository is implemented in the form of HPC grid 108. In alternative embodiments, such a centralized repository can be implemented through other storage mechanisms, such as through a distributed database system in a cloud computing environment, etc. In operation G, harvesting automaton sends publications that it harvested from various different social media sites 104A-N to HPC grid 108 for storage.

For each publication that harvesting automaton 106 causes to be stored in HPC grid 108, harvesting automaton 106 can instruct HPC grid 108 to store that publication in association with an identity of a user from whose social media account the information was obtained. It is possible that the same user might have different account identifiers for different accounts maintained among different social media sites 104A-N. Along with publications, harvesting automaton 106 can also send, to HPC grid 108, related account identifiers of the social media site accounts from which the publications were harvested. HPC grid 108 can, in response to receiving this information, store publications harvested from any social media site account in association with the account identifier corresponding to that account. In some embodiments, in addition to publications, harvesting automaton 106 also can read, from social media sites 104A-N, additional information pertaining to user accounts, such as demographic information (if within the scopes of the permissions granted by the authorization tokens corresponding to those accounts). In such embodiments, harvesting automaton 106 can further cause HPC grid 108 to store this additional information in association with the account identifiers of the social media accounts from which the additional information was obtained. In some embodiments, harvesting automaton 106 can store authorization tokens for a user's various accounts in association with the account identifiers for these accounts.

In some embodiments, harvesting automaton 106 can execute on user device 102. In some embodiments, separate instances of harvesting automaton 106 can execute on servers at each of on-line search engines 110A-N. In some embodiments, harvesting automaton can execute on a server that is independent of any other component shown in FIG. 1.

Asynchronously to the operations discussed above, in operation H, user device 102 sends a request, specifying one or more search query terms, over a system of interconnected networks (including the Internet) to any of on-line search engines 110A-N. Search engines 110A-N can be operated by different entities (e.g., Google, Yahoo, Bing, etc.), but each can be configured to search internet-accessible content (e.g., web pages), previously discovered and indexed by automated web crawling processes, for content that is relevant to specified search query terms. In addition to the search query terms, the request from user device 102 also can contain information identifying a user of that device; for example, the request can contain one or more of the user's social media site account identifiers, as read from cookies that an Internet browser application previously stored on user device 102 while browsing resources associated with those social media site accounts.

The search engine receiving the request from user device 102 can rank search results in order of relevance to the search query terms. That search engine can dynamically generate a search results web page into which it can insert summaries of and hyperlinks to at least some of the ranked search results. The search engine can also insert, into the search results web page, advertisements selected based on their relevance to the search query terms only. Some of these advertisements can be sponsored advertisements originating from advertisers who have agreed to pay to have the search engine display those advertisements on search results web pages that are relevant to their advertised products or services.

In operation J, independent of operations that select these search query term-based, potentially sponsored advertisements, the search engine that received the request from user device 102 reads, from HPC grid 108, publications (and potentially additional information) that are stored in association with a user identity (e.g., one or more social media site account identifiers obtained from one or more cookies stored on user device 102) that was contained in the request. Based on the content of these publications, the search engine can formulate one or more social advertising keywords.

An example technique for generating social advertising keywords involves the automatic extraction and use, as keywords, of proper nouns within the publications, although numerous other techniques could be used instead. The generation of the social advertising keywords also can include the use of demographic or other information about the user of user device 102, if such information was available in HPC grid 108. In some embodiments, the social advertising keywords can include one or more of the search query terms. In other embodiments, the social advertising keywords intentionally exclude the search query terms. The search engine can perform these operations as a part of the operations that it performs in dynamically generating a search results web page.

In operation K, the search engine that generated the social advertising keywords sends a separate query specifying the social advertising keywords to advertisement server 112. The search engine can send the separate query over a system of interconnected computing networks including the Internet.

Advertisement server 112 can be implemented as one or more processes that execute on one or more computing devices. These computing devices can maintain a database of advertisements that are associated with keywords. In operation L, in response to receiving the social advertising keywords in the query from the search engine, advertisement server 112 selects one or more advertisements that are associated with keywords that match the social advertising keywords. At least some of the selected advertisements may be included as social advertisements (separate and distinct from other advertisements) within the search results web page being dynamically generated by the search engine. Also in operation L, advertisement server 112 sends the selected advertisements back to the search engine in response to the query that the search engine sent in operation K.

In operation M, the search engine receives the selected advertisements and inserts one or more of the selected advertisements into a section of the search results web page dedicated solely to social advertisements. The advertisements inserted into this section are the social advertisements. This section is visibly separate from and demarcated from sections containing other kinds of advertisements, such as search query term-only-based and sponsored advertisements. Different advertising sections within the search results web page can be labeled differently, with the section containing the social advertisements being labeled as “social advertisements.” Also in operation M, the search engine can send back, to user device 102, the social advertisement-containing search results web page in response to the request that user device 102 sent in operation H. It should be understood that any of search engines 110A-N receiving the request in operation H can perform operations J, K, and M.

In operation N, an Internet browser application executing on user device 102 receives the social advertisement-containing search results web page and displays that web page to its user. Consequently, the user's web search experience is enhanced by social advertisements that are likely to relate more specifically to subjects in which the user is interested, for these social advertisements are based on social media data that tends to be of a more personal, individually-focused, interest-revealing nature.

### Privacy

As is discussed above, in some embodiments, harvesting automaton 106 harvests publications from social media sites 104A-N and stores these publications in HPC grid 108. In some embodiments, the only kinds of publications that harvesting automaton 106 harvests from social media sites 104A-N are publications that are marked, by those sites, as having a public level of visibility. In such embodiments, harvesting automaton 106 does not harvest from social media sites 104A-N, or store in HPC grid 108, any publications that in any way are constrained to be visible to a limited audience.

Furthermore, in some embodiments, unless a user has authorized harvesting automaton 106 to access his publications from a specific social media site (e.g., using the OAuth procedure discussed above), harvesting automaton 106 is incapable of accessing that user's publications maintained at that specific social media site. Thus, through this mechanism, in some embodiments, a user specifically and deliberately manifests consent in order to “opt in.”

### Freshness

In some embodiments, each harvested publication stored within HPC grid 108 is stored with a timestamp that indicates a date on which that publication was obtained from any of social media sites 104A-N. In such embodiments, a garbage-collecting process executing within HPC grid 108 periodically checks the timestamps associated with each of the publications stored in HPC grib 108. For any timestamps that are older than a specified threshold age (e.g., one month), the garbage-collecting process deletes, from HPC grid 108, the publications that are associated with those timestamps.

### Multi-Request API

As is discussed above, harvesting automaton 106 can interface with an API in order to read publications from different social media sites 104A-N. This API can be a representational state transfer (REST)-based API. In some embodiments, the input that harvesting automaton 106 submits to the routines of this API identifies a user (e.g., a user of device 102). In response to receiving this input, the routines of the API harvest publications from all of the accounts of the user on all of social media sites 104A-N in which such accounts exist. In order to achieve this multiplicity, harvesting automaton 106 can map a global user identity to various different account identifiers for the user's accounts on social media sites 104A-N. Alternatively, harvesting automaton can provide multiple user account identifiers as input to the API.

Thus, in such embodiments, harvesting automaton does not need to make separate calls to separate social media sites 104A-N. In some embodiments, the routines of the API can be constrained to read or request publications only from social media accounts for which harvesting automaton 106 has obtained or can obtain an authorization token, as discussed above. The API routines can return data harvested from multiple social media sites 104A-N in a single standardized JavaScript Object Notation (JSON) response.

### Canonical Publication Format

As is discussed above, harvesting automaton 106 can call routines of a representational state transfer (REST)-based API in order to harvest publications from multiple social media sites 104A-N at once. The publications stored at different social media sites 104A-N can be formatted differently, with different kinds of data in different fields. In order to achieve some degree of uniformity, in some embodiments, rather than returning the raw publications in their original formats to harvesting automaton 106, the routines of the API can reformat the behaviors (and possibly additional data, such as demographic information) harvested from social media sites 104A-N to conform to a standard canonical format or schema.

For each of social media sites 104A-N, the API can maintain a mapping between (a) various fields used by the format of that site and (b) corresponding fields in a canonically formatted data structure. The API can use this mapping to place, into appropriate fields of the canonically formatted data structure, data extracted from various corresponding fields of data formatted according to site-specific structures. Harvesting automaton 106 can store behaviors and other data within canonically formatted data structures in HPC 108, so that the data stored in HPC 108 conforms to the same canonical format regardless of the source from whence it was harvested.

### Advertising Contexts

Although embodiments discussed above pertain specifically to the selection and display of social advertisements within search results web pages generated by on-line search results engines 110A-N, alternative embodiments can involve such social advertisements being inserted into other kinds of media. For example, in some embodiments, various other web servers not associated with search can dynamically select such social advertisements using techniques described above, and can dynamically insert such social advertisements into the web pages that they serve to user devices. Additionally, in some embodiments, social advertisements selected using techniques discussed above can be provided to non-online advertisers in order to help those advertisers to target their advertising campaigns.

### Segregation of Advertisements by Type in Search Results Web Page

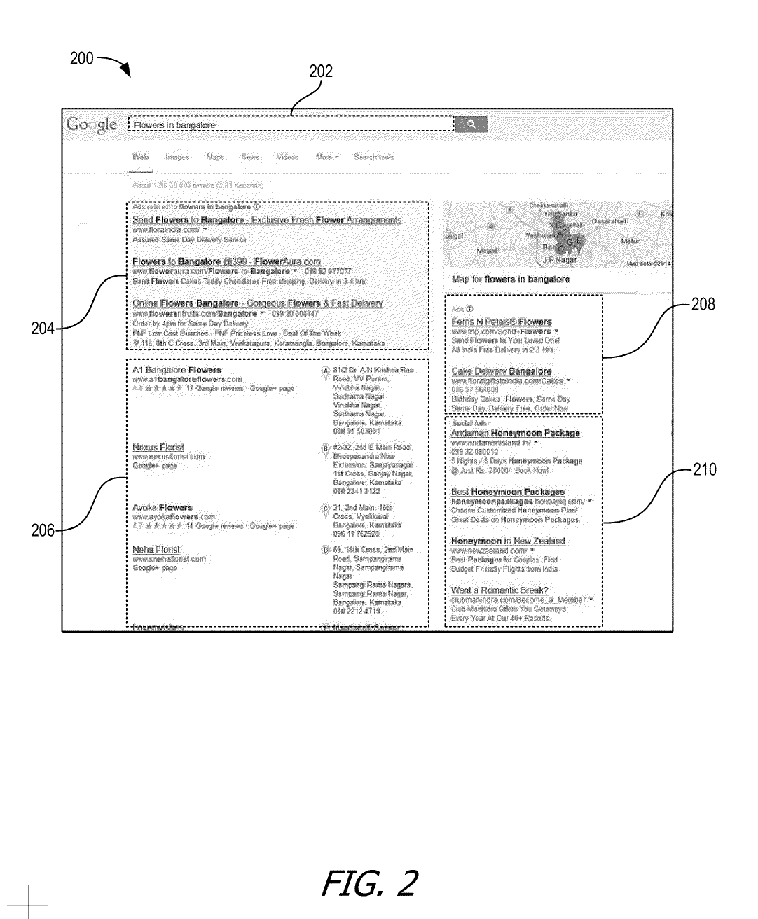

As is discussed above, in some embodiments, search results web pages generated by any of on-line search engines 110A-N include visibly distinct, separate sections for social advertisements and for other kinds of advertisements chosen based on other criteria (e.g., based only on search query terms or based on sponsoring). FIG. 2 is a diagram that illustrates an example of a search results web page 200 that includes multiple distinct sections, one of which is devoted exclusively to social advertisements, according to some embodiments.

Search results web page 200 includes a search query terms section 202, a sponsored advertisement section 204, an organic search results section 206, a search-query-term-only advertisement section 208, and a social advertisement section 210. As can be seen in web page 200, social advertisement section 210 is clearly distinct and separate from sections 202-208. Social advertisement section 210 is labeled “Social Ads” in FIG. 2.

In some embodiments, although the content selected for presentation in each of sections 204-210 can be based at least in part on search query terms (in this example, Flowers in Bangalore”) entered in section 202, social advertisements in social advertisement section 210 are the only contents that are selected based on keywords derived from publications harvested from social media site accounts of the specific user who supplied the search query terms.

### Example Search Results Web Page Generation Technique

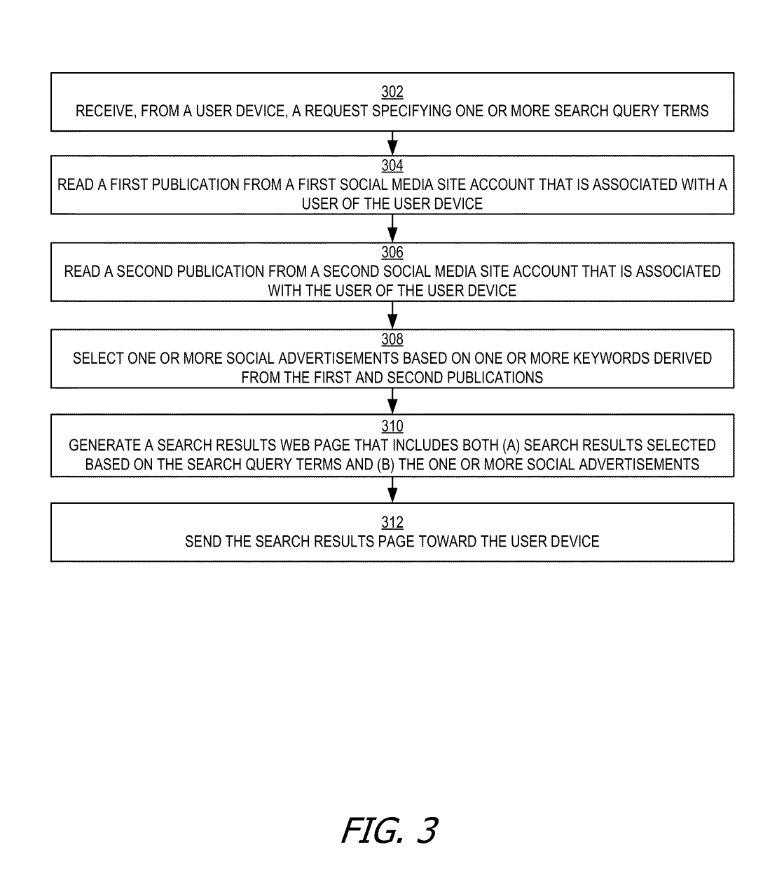

FIG. 3 is a flow diagram that illustrates a technique for generating a search results web page that includes social advertisements selected based on publications harvested from a user's various social media site accounts, according to some embodiments. Although FIG. 3 illustrates operations being performed in a specific order, alternative embodiments can involve additional or fewer operations being performed in the same or in different orders. The technique illustrated in FIG. 3 can be performed by a process executing on a computing device such as a search engine server, for example.

In block 302, a request specifying one or more search query terms is received from a user device. For example, search engine 110B can receive such a request from user device 102 over the Internet.

In block 304, a first publication originating from a first social media site account that is associated with a user of the user device is read. For example, search engine 110B can read such a first publication from HPC grid 108. The first publication can have originated from a social media site account of the user of user device 102 on social media site 104A. The first publication might be a Facebook status update, for example.

In block 306, a second publication originating from a second social media site account that is associated with the user of the user device is read. For example, search engine 110B can read such a second publication from HPC grid 108. The second publication can have originated from a social media site account of the user of user device 102 on social media site 104B. The second publication might be a Twitter tweet, for example.

In block 308, one or more social advertisements are selected based on one or more keywords derived from the first and second publications. For example, search engine 110B can request, from advertisement server 112, social advertisements that are based on keywords derived from Facebook status updates and Twitter tweets of the user of user device 102.

In block 310, a search results web page that includes both (a) search results selected based on the search query terms and (b) the one or more social advertisements is generated. For example, search engine 110B can generate a search results web page that includes both (a) summaries of and hyperlinks to web pages that are relevant to the search query terms received in block 302, and, separately, (b) the social advertisements selected in block 308.

In block 312, the search results page is sent toward the user device. For example, search engine 110B can send the search results page generated in block 310 over the Internet toward user device 102 in response to the request received in block 302.

### Hardware Overview

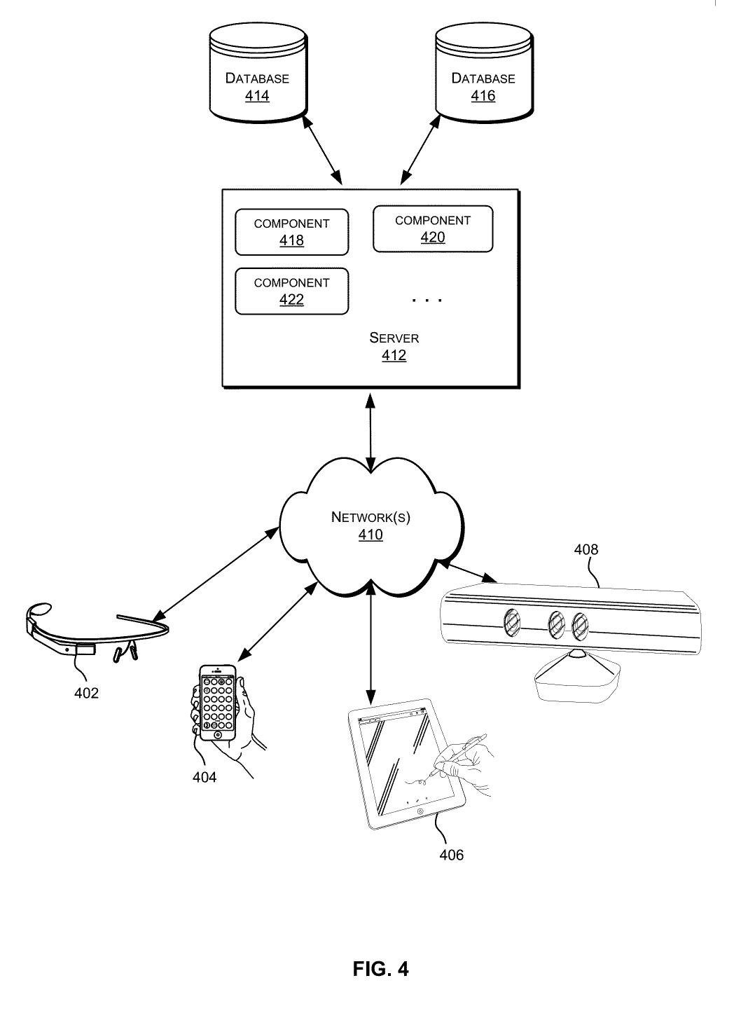

FIG. 4 depicts a simplified diagram of a distributed system 400 for implementing one of the embodiments. In the illustrated embodiment, distributed system 400 includes one or more client computing devices 402, 404, 406, and 408, which are configured to execute and operate a client application such as a web browser, proprietary client (e.g., Oracle Forms), or the like over one or more network(s) 410. Server 412 may be communicatively coupled with remote client computing devices 402, 404, 406, and 408 via network 410.

In various embodiments, server 412 may be adapted to run one or more services or software applications provided by one or more of the components of the system. In some embodiments, these services may be offered as web-based or cloud services or under a Software as a Service (SaaS) model to the users of client computing devices 402, 404, 406, and/or 408. Users operating client computing devices 402, 404, 406, and/or 408 may in turn utilize one or more client applications to interact with server 412 to utilize the services provided by these components.

In the configuration depicted in the figure, the software components 418, 420 and 422 of system 400 are shown as being implemented on server 412. In other embodiments, one or more of the components of system 400 and/or the services provided by these components may also be implemented by one or more of the client computing devices 402, 404, 406, and/or 408. Users operating the client computing devices may then utilize one or more client applications to use the services provided by these components. These components may be implemented in hardware, firmware, software, or combinations thereof. It should be appreciated that various different system configurations are possible, which may be different from distributed system 400. The embodiment shown in the figure is thus one example of a distributed system for implementing an embodiment system and is not intended to be limiting.

Client computing devices 402, 404, 406, and/or 408 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 402, 404, 406, and 408 may be any other electronic device, such as a thin-client computer, an Internet-enabled gaming system (e.g., a Microsoft Xbox gaming console with or without a Kinect® gesture input device), and/or a personal messaging device, capable of communicating over network(s) 410.

Although exemplary distributed system 400 is shown with four client computing devices, any number of client computing devices may be supported. Other devices, such as devices with sensors, etc., may interact with server 412.

Network(s) 410 in distributed system 400 may be any type of network familiar to those skilled in the art that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 410 can be a local area network (LAN), such as one based on Ethernet, Token-Ring and/or the like. Network(s) 410 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 412 may be composed of one or more general purpose computers, specialized server computers (including, by way of example, PC (personal computer) servers, UNIXO servers, mid-range servers, mainframe computers, rack-mounted servers, etc.), server farms, server clusters, or any other appropriate arrangement and/or combination. In various embodiments, server 412 may be adapted to run one or more services or software applications described in the foregoing disclosure. For example, server 412 may correspond to a server for performing processing described above according to an embodiment of the present disclosure.

Server 412 may run an operating system including any of those discussed above, as well as any commercially available server operating system. Server 412 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 412 may include one or more applications to analyze and consolidate data feeds and/or event updates received from users of client computing devices 402, 404, 406, and 408. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 412 may also include one or more applications to display the data feeds and/or real-time events via one or more display devices of client computing devices 402, 404, 406, and 408.

Distributed system 400 may also include one or more databases 414 and 416. Databases 414 and 416 may reside in a variety of locations. By way of example, one or more of databases 414 and 416 may reside on a non-transitory storage medium local to (and/or resident in) server 412. Alternatively, databases 414 and 416 may be remote from server 412 and in communication with server 412 via a network-based or dedicated connection. In one set of embodiments, databases 414 and 416 may reside in a storage-area network (SAN). Similarly, any necessary files for performing the functions attributed to server 412 may be stored locally on server 412 and/or remotely, as appropriate. In one set of embodiments, databases 414 and 416 may include relational databases, such as databases provided by Oracle, which are adapted to store, update, and retrieve data in response to SQL-formatted commands.

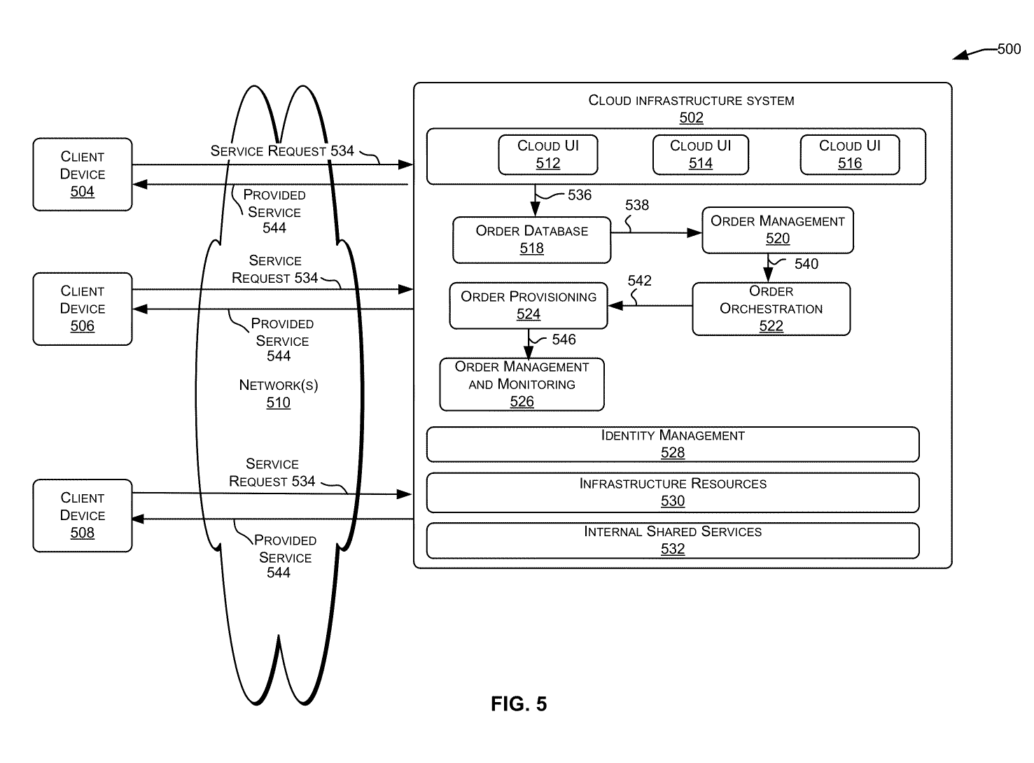

FIG. 5 is a simplified block diagram of one or more components of a system environment 500 by which services provided by one or more components of an embodiment system may be offered as cloud services, in accordance with an embodiment of the present disclosure. In the illustrated embodiment, system environment 500 includes one or more client computing devices 504, 506, and 508 that may be used by users to interact with a cloud infrastructure system 502 that provides cloud services. The client computing devices may be configured to operate a client application such as a web browser, a proprietary client application (e.g., Oracle Forms), or some other application, which may be used by a user of the client computing device to interact with cloud infrastructure system 502 to use services provided by cloud infrastructure system 502.

It should be appreciated that cloud infrastructure system 502 depicted in the figure may have other components than those depicted. Further, the embodiment shown in the figure is only one example of a cloud infrastructure system that may incorporate an embodiment of the invention. In some other embodiments, cloud infrastructure system 502 may have more or fewer components than shown in the figure, may combine two or more components, or may have a different configuration or arrangement of components.

Client computing devices 504, 506, and 508 may be devices similar to those described above for 402, 404, 406, and 408.

Although exemplary system environment 500 is shown with three client computing devices, any number of client computing devices may be supported. Other devices such as devices with sensors, etc. may interact with cloud infrastructure system 502.

Network(s) 510 may facilitate communications and exchange of data between clients 504, 506, and 508 and cloud infrastructure system 502. Each network may be any type of network familiar to those skilled in the art that can support data communications using any of a variety of commercially available protocols, including those described above for network(s) 410.

Cloud infrastructure system 502 may comprise one or more computers and/or servers that may include those described above for server 412.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 502 may include a suite of applications, middleware, and database service offerings that are delivered to a customer in a self-service, subscription-based, elastically scalable, reliable, highly available, and secure manner. An example of such a cloud infrastructure system is the Oracle Public Cloud provided by the present assignee.

In various embodiments, cloud infrastructure system 502 may be adapted to automatically provision, manage and track a customer's subscription to services offered by cloud infrastructure system 502. Cloud infrastructure system 502 may provide the cloud services via different deployment models. For example, services may be provided under a public cloud model in which cloud infrastructure system 502 is owned by an organization selling cloud services (e.g., owned by Oracle) and the services are made available to the general public or different industry enterprises. As another example, services may be provided under a private cloud model in which cloud infrastructure system 502 is operated solely for a single organization and may provide services for one or more entities within the organization. The cloud services may also be provided under a community cloud model in which cloud infrastructure system 502 and the services provided by cloud infrastructure system 502 are shared by several organizations in a related community. The cloud services may also be provided under a hybrid cloud model, which is a combination of two or more different models.

In some embodiments, the services provided by cloud infrastructure system 502 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 502. Cloud infrastructure system 502 then performs processing to provide the services in the customer's subscription order.

In some embodiments, the services provided by cloud infrastructure system 502 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations (such as Oracle) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support. Examples of platform services include, without limitation, Oracle Java Cloud Service (JCS), Oracle Database Cloud Service (DBCS), and others.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services (e.g., Oracle Fusion Middleware services), and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 502 may also include infrastructure resources 530 for providing the resources used to provide various services to customers of the cloud infrastructure system. In one embodiment, infrastructure resources 530 may include pre-integrated and optimized combinations of hardware, such as servers, storage, and networking resources to execute the services provided by the PaaS platform and the SaaS platform.

In some embodiments, resources in cloud infrastructure system 502 may be shared by multiple users and dynamically re-allocated per demand. Additionally, resources may be allocated to users in different time zones. For example, cloud infrastructure system 530 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 532 may be provided that are shared by different components or modules of cloud infrastructure system 502 and by the services provided by cloud infrastructure system 502. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 502 may provide comprehensive management of cloud services (e.g., SaaS, PaaS, and IaaS services) in the cloud infrastructure system. In one embodiment, cloud management functionality may include capabilities for provisioning, managing, and tracking a customer's subscription received by cloud infrastructure system 502, and the like.

In one embodiment, as depicted in the figure, cloud management functionality may be provided by one or more modules, such as an order management module 520, an order orchestration module 522, an order-provisioning module 524, an order management and monitoring module 526, and an identity management module 528. These modules may include or be provided using one or more computers and/or servers, which may be general purpose computers, specialized server computers, server farms, server clusters, or any other appropriate arrangement and/or combination.

In exemplary operation 534, a customer using a client device, such as client device 504, 506 or 508, may interact with cloud infrastructure system 502 by requesting one or more services provided by cloud infrastructure system 502 and placing an order for a subscription for one or more services offered by cloud infrastructure system 502. In certain embodiments, the customer may access a cloud User Interface (UI), cloud UI 512, cloud UI 514 and/or cloud UI 516 and place a subscription order via these UIs. The order information received by cloud infrastructure system 502 in response to the customer placing an order may include information identifying the customer and one or more services offered by the cloud infrastructure system 502 that the customer intends to subscribe to.

After an order has been placed by the customer, the order information is received via the cloud UIs, 512, 514 and/or 516.

At operation 536, the order is stored in order database 518. Order database 518 can be one of several databases operated by cloud infrastructure system 518 and operated in conjunction with other system elements.

At operation 538, the order information is forwarded to an order management module 520. In some instances, order management module 520 may be configured to perform billing and accounting functions related to the order, such as verifying the order, and upon verification, booking the order.

At operation 540, information regarding the order is communicated to an order orchestration module 522. Order orchestration module 522 may utilize the order information to orchestrate the provisioning of services and resources for the order placed by the customer. In some instances, order orchestration module 522 may orchestrate the provisioning of resources to support the subscribed services using the services of order provisioning module 524.

In certain embodiments, order orchestration module 522 enables the management of business processes associated with each order and applies business logic to determine whether an order should proceed to provisioning. At operation 542, upon receiving an order for a new subscription, order orchestration module 522 sends a request to order provisioning module 524 to allocate resources and configure those resources needed to fulfill the subscription order. Order provisioning module 524 enables the allocation of resources for the services ordered by the customer. Order provisioning module 524 provides a level of abstraction between the cloud services provided by cloud infrastructure system 500 and the physical implementation layer that is used to provision the resources for providing the requested services. Order orchestration module 522 may thus be isolated from implementation details, such as whether or not services and resources are actually provisioned on the fly or pre-provisioned and only allocated/assigned upon request.

At operation 544, once the services and resources are provisioned, a notification of the provided service may be sent to customers on client devices 504, 506 and/or 508 by order provisioning module 524 of cloud infrastructure system 502.

At operation 546, the customer's subscription order may be managed and tracked by an order management and monitoring module 526. In some instances, order management and monitoring module 526 may be configured to collect usage statistics for the services in the subscription order, such as the amount of storage used, the amount data transferred, the number of users, and the amount of system up time and system down time.

In certain embodiments, cloud infrastructure system 500 may include an identity management module 528. Identity management module 528 may be configured to provide identity services, such as access management and authorization services in cloud infrastructure system 500. In some embodiments, identity management module 528 may control information about customers who wish to utilize the services provided by cloud infrastructure system 502. Such information can include information that authenticates the identities of such customers and information that describes which actions those customers are authorized to perform relative to various system resources (e.g., files, directories, applications, communication ports, memory segments, etc.) Identity management module 528 may also include the management of descriptive information about each customer and about how and by whom that descriptive information can be accessed and modified.

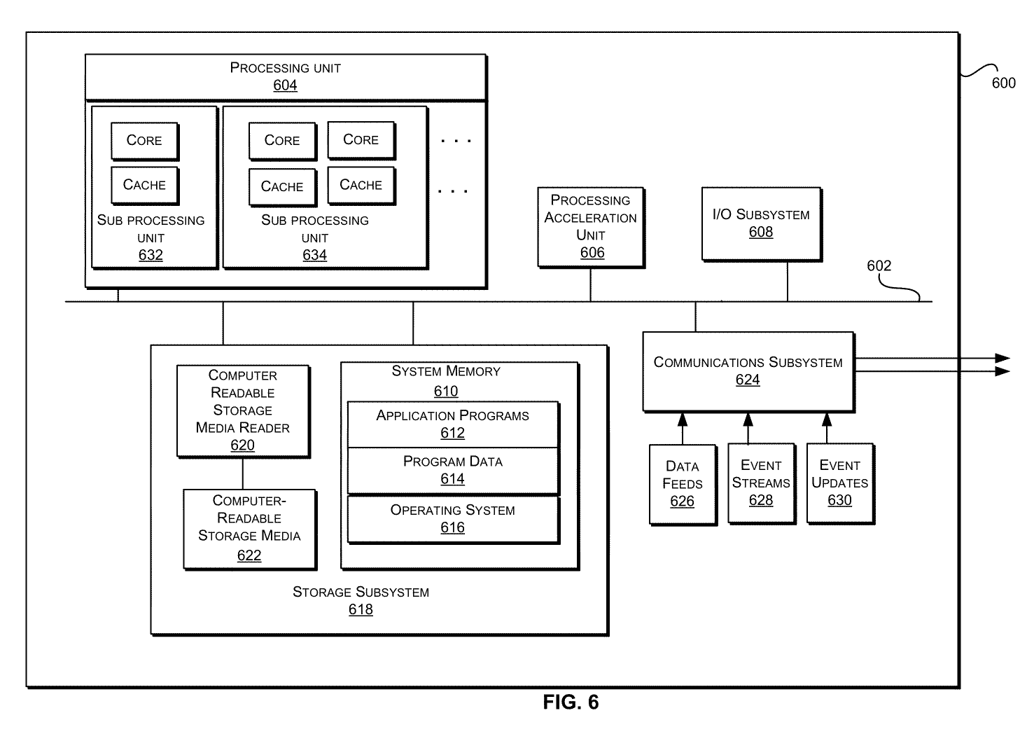

FIG. 6 illustrates an example computer system 600 in which various embodiments of the present invention may be implemented. The system 600 may be used to implement any of the computer systems described above. As shown in the figure, computer system 600 includes a processing unit 604 that communicates with a number of peripheral subsystems via a bus subsystem 602. These peripheral subsystems may include a processing acceleration unit 606, an I/O subsystem 608, a storage subsystem 618 and a communications subsystem 624. Storage subsystem 618 includes tangible computer-readable storage media 622 and a system memory 610.

Bus subsystem 602 provides a mechanism for letting the various components and subsystems of computer system 600 communicate with each other as intended. Although bus subsystem 602 is shown schematically as a single bus, alternative embodiments of the bus subsystem may utilize multiple buses. Bus subsystem 602 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus.

Processing unit 604, which can be implemented as one or more integrated circuits (e.g., a conventional microprocessor or microcontroller), controls the operation of computer system 600. One or more processors may be included in processing unit 604. These processors may include single core or multicore processors. In certain embodiments, processing unit 604 may be implemented as one or more independent processing units 632 and/or 634 with single or multicore processors included in each processing unit. In other embodiments, processing unit 604 may also be implemented as a quad-core processing unit formed by integrating two dual-core processors into a single chip.

In various embodiments, processing unit 604 can execute a variety of programs in response to program code and can maintain multiple concurrently executing programs or processes. At any given time, some or all of the program code to be executed can be resident in processor(s) 604 and/or in storage subsystem 618. Through suitable programming, processor(s) 604 can provide various functionalities described above. Computer system 600 may additionally include a processing acceleration unit 606, which can include a digital signal processor (DSP), a special-purpose processor, and/or the like.

I/O subsystem 608 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 600 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 600 may comprise a storage subsystem 618 that comprises software elements, shown as being currently located within a system memory 610. System memory 610 may store program instructions that are loadable and executable on processing unit 604, as well as data generated during the execution of these programs.

Depending on the configuration and type of computer system 600, system memory 610 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 604. In some implementations, system memory 610 may include multiple different types of memory, such as static random access memory (SRAM) or dynamic random access memory (DRAM). In some implementations, a basic input/output system (BIOS), containing the basic routines that help to transfer information between elements within computer system 600, such as during start-up, may typically be stored in the ROM. By way of example, and not limitation, system memory 610 also illustrates application programs 612, which may include client applications, Web browsers, mid-tier applications, relational database management systems (RDBMS), etc., program data 614, and an operating system 616. By way of example, operating system 616 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 6 OS, and Palm® OS operating systems.

Storage subsystem 618 may also provide a tangible computer-readable storage medium for storing the basic programming and data constructs that provide the functionality of some embodiments. Software (programs, code modules, instructions) that when executed by a processor provide the functionality described above may be stored in storage subsystem 618. These software modules or instructions may be executed by processing unit 604. Storage subsystem 618 may also provide a repository for storing data used in accordance with the present invention.

Storage subsystem 600 may also include a computer-readable storage media reader 620 that can further be connected to computer-readable storage media 622. Together and, optionally, in combination with system memory 610, computer-readable storage media 622 may comprehensively represent remote, local, fixed, and/or removable storage devices plus storage media for temporarily and/or more permanently containing, storing, transmitting, and retrieving computer-readable information.

Computer-readable storage media 622 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 600.

By way of example, computer-readable storage media 622 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 622 may include, but is not limited to, Zip® drives, flash memory cards, universal serial bus (USB) flash drives, secure digital (SD) cards, DVD disks, digital video tape, and the like. Computer-readable storage media 622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 600.

Communications subsystem 624 provides an interface to other computer systems and networks. Communications subsystem 624 serves as an interface for receiving data from and transmitting data to other systems from computer system 600. For example, communications subsystem 624 may enable computer system 600 to connect to one or more devices via the Internet. In some embodiments communications subsystem 624 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 624 can provide wired network connectivity (e.g., Ethernet) in addition to or instead of a wireless interface.

In some embodiments, communications subsystem 624 may also receive input communication in the form of structured and/or unstructured data feeds 626, event streams 628, event updates 630, and the like on behalf of one or more users who may use computer system 600.

By way of example, communications subsystem 624 may be configured to receive data feeds 626 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 624 may also be configured to receive data in the form of continuous data streams, which may include event streams 628 of real-time events and/or event updates 630, which may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like. Communications subsystem 624 may also be configured to output the structured and/or unstructured data feeds 626, event streams 628, event updates 630, and the like to one or more databases that may be in communication with one or more streaming data source computers coupled to computer system 600.

Computer system 600 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 600 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

In the foregoing specification, aspects of the invention are described with reference to specific embodiments thereof, but those skilled in the art will recognize that the invention is not limited thereto. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
receiving, at a computing device, from a user device, a request specifying one or more search query terms;
reading, by the computing device, a first publication originating from a first social media site account that is associated with a user of the user device;
selecting, by the computing device, one or more social advertisements based on one or more keywords derived from the first publication;
generating, by the computing device, a search results web page that includes both (a) search results selected based on the search query terms and (b) the one or more social advertisements; and
sending the search results page toward the user device.

2. The method of claim 1, further comprising:
reading, by the computing device, a second publication originating from a second social media site account that is associated with the user of the device;
wherein the second social media site account pertains to a social media site that differs from a social media site to which the first social media site account pertains; and
wherein the one or more keywords are also derived from the second publication.

3. The method of claim 2, wherein reading the first publication and reading the second publication comprises:
placing a single call to a routine of an application programming interface that reads the first and second publications in response to the single call.

4. The method of claim 2, further comprising:
maintaining a first mapping between (a) fields of a first structure that stores the first publication and (b) fields of a canonical structure that correspond to the fields of the first structure;
maintaining a second mapping between (c) fields of a second structure that stores the second publication and (d) fields of the canonical structure that correspond to the fields of the second structure;
based on the first mapping, storing information from the first publication in fields of a first instance of the canonical structure; and
based on the second mapping, storing information from the second publication in fields of a second instance of the canonical structure;
wherein the first structure differs from the second structure.

5. The method of claim 1, wherein generating the search results web page that includes both the search results selected based on the search query terms and the one or more social advertisements comprises:
generating a search results page that includes (a) a first section that only contains the one or more social advertisements and (b) a second section, visually distinct from the first section, that only contains one or more advertisements selected based on criteria excluding keywords derived from the publication.

6. The method of claim 1, wherein the first publication is a Facebook status update.

7. The method of claim 1, wherein the first publication is a Twitter tweet.

8. A non-transitory computer-readable storage memory storing instructions which, when executed by one or more processors, cause the one or more processors to perform operations comprising:
receiving from a user device, a request specifying one or more search query terms;
reading a first publication originating from a first social media site account that is associated with a user of the user device;
selecting one or more social advertisements based on one or more keywords derived from the publication;
generating a search results web page that includes both (a) search results selected based on the search query terms and (b) the one or more social advertisements; and
sending the search results page toward the user device.

9. The non-transitory computer-readable storage memory of claim 8, wherein the operations further comprise:
reading, by the computing device, a second publication originating from a second social media site account that is associated with the user of the device;
wherein the second social media site account pertains to a social media site that differs from a social media site to which the first social media site account pertains; and
wherein the one or more keywords are also derived from the second publication.

10. The non-transitory computer-readable storage memory of claim 9, wherein reading the first publication and reading the second publication comprises:
placing a single call to a routine of an application programming interface that reads the first and second publications in response to the single call.

11. The non-transitory computer-readable storage memory of claim 9, wherein the operations further comprise:
maintaining a first mapping between (a) fields of a first structure that stores the first publication and (b) fields of a canonical structure that correspond to the fields of the first structure;
maintaining a second mapping between (c) fields of a second structure that stores the second publication and (d) fields of the canonical structure that correspond to the fields of the second structure;
based on the first mapping, storing information from the first publication in fields of a first instance of the canonical structure; and
based on the second mapping, storing information from the second publication in fields of a second instance of the canonical structure;
wherein the first structure differs from the second structure.

12. The non-transitory computer-readable storage memory of claim 8, wherein generating the search results web page that includes both the search results selected based on the search query terms and the one or more social advertisements comprises:
generating a search results page that includes (a) a first section that only contains the one or more social advertisements and (b) a second section, visually distinct from the first section, that only contains one or more advertisements selected based on criteria excluding keywords derived from the publication.

13. The non-transitory computer-readable storage memory of claim 8, wherein the first publication is a Facebook status update.

14. The non-transitory computer-readable storage memory of claim 8, wherein the first publication is a Twitter tweet.

15. A system comprising:
one or more processors; and
a computer-readable memory storing instructions executable by the one or more processors to cause the one or more processors to perform operations comprising:
receiving from a user device, a request specifying one or more search query terms;
reading a first publication originating from a first social media site account that is associated with a user of the user device;
selecting one or more social advertisements based on one or more keywords derived from the publication;
generating a search results web page that includes both (a) search results selected based on the search query terms and (b) the one or more social advertisements; and
sending the search results page toward the user device.

16. The system of claim 15, wherein the operations further comprise:
reading, by the computing device, a second publication originating from a second social media site account that is associated with the user of the device;
wherein the second social media site account pertains to a social media site that differs from a social media site to which the first social media site account pertains; and
wherein the one or more keywords are also derived from the second publication.

17. The system of claim 16, wherein reading the first publication and reading the second publication comprises:
placing a single call to a routine of an application programming interface that reads the first and second publications in response to the single call.

18. The system of claim 16, wherein the operations further comprise:
maintaining a first mapping between (a) fields of a first structure that stores the first publication and (b) fields of a canonical structure that correspond to the fields of the first structure;
maintaining a second mapping between (c) fields of a second structure that stores the second publication and (d) fields of the canonical structure that correspond to the fields of the second structure;
based on the first mapping, storing information from the first publication in fields of a first instance of the canonical structure; and
based on the second mapping, storing information from the second publication in fields of a second instance of the canonical structure;
wherein the first structure differs from the second structure.

19. The system of claim 15, wherein generating the search results web page that includes both the search results selected based on the search query terms and the one or more social advertisements comprises:
generating a search results page that includes (a) a first section that only contains the one or more social advertisements and (b) a second section, visually distinct from the first section, that only contains one or more advertisements selected based on criteria excluding keywords derived from the publication.

20. The system of claim 15, wherein the first publication is either a Facebook status update or a Twitter tweet.
